(19) United States
(12) Patent Application Publication
(10) Pub. No.: US 2010/0128588 A1
(43) Pub. Date: May 27, 2010

(54) Halloween greeting system

(76) Inventor: Barry M. Shuman, Woodland Hills, CA (US)

Correspondence Address: Barry M. Shuman, 21616 Califa Street, Apt 126, Woodland Hills, CA, 91367, US

(21) Appl. No.: 12/315,136

(22) Filed: Nov. 26, 2008

(51) Int. Cl. G11B 31/00

(52) U.S. Cl. 369/63; G9B/31

(57) ABSTRACT

A Halloween greeting system for prompting young children to remember to say “trick or treat” and “thank you” is provided. The greeting system includes a Halloween treat container that has a voice recorder/audio player; and a remote control unit for triggering the voice recorder/audio player to play a recorded message.

### FIELD OF THE INVENTION

The present invention relates to a Halloween greeting system to be used with a Halloween treat container. More specifically, the present invention relates to a system designed to help young children remember to say “trick or treat” and “thank you.”

### BACKGROUND OF THE INVENTION

Halloween is a tradition enjoyed by many young children, as well as older children, and some adults. Halloween activities include costume parties, scary attractions, carving jack-o'-lanterns, and trick-or-treating. Trick-or-treating is perhaps the most enjoyable activity for young children. During trick-or-treating, young children typically canvass the neighborhood accompanied by their parents or other adult chaperones. The children ring bells and/or knock on doors and then say (or should say) “trick or treat” and then “thank you” upon receipt of a treat.

However, as many parents of young children can attest to, trick-or-treating can be a little chaotic. Frequently, the children run from one house to another, commonly forgetting to say “trick or treat,” and perhaps more commonly forgetting to say “thank you.” And as many parents of “first time” trick-or-treaters have realized, the whole Halloween experience can be a little overwhelming for very young children. These “first time” trick-or-treaters probably have a very limited vocabulary. Therefore, these “first timers” might not really know what they are supposed to say.

A solution to the above problems is to have the parent or chaperone remind/tell the child what the child should say. However, this solution can be tiring for the parent/chaperone, as a lot of repetition is typically involved. Also, the parent might find the child is not within earshot range and/or the child is surrounded by several other children. Thus, it might be difficult for the parent to get the child's attention and/or for the child to hear the parent. Therefore, there is a need for product that helps solve the above problems.

Many examples of remote control units being used with toys and other devices are known and disclosed in U.S. patents and U.S. patent application Publications, including U.S. Pat. Nos. 6,757,393, 6,697,602, 6,881,122, 7,210,656 and U.S. Patent Application Publication No. 2008/0231740, the disclosures of which are hereby incorporated by reference in their entirety for all purposes.

### SUMMARY OF THE INVENTION

It is an object of the present invention to provide a Halloween greeting system that includes a Halloween treat container with a voice recorder/audio player; and a remote control unit that can be used to trigger the voice recorder/audio player to play a recorded message.

It is another object of the present invention to provide a Halloween greeting system that includes a voice recorder/audio player that can be removably attached to a Halloween treat container; and a remote control unit that can be used to trigger the voice recorder/audio player to play a recorded message.

It is another object of the present invention to provide a Halloween greeting system kit that includes a voice recorder/audio player that can be removably attached to a Halloween treat container; a remote control unit that can be used to trigger the voice recorder/audio player to play a recorded message; and an attachment for attaching the voice recorder/audio player to the Halloween treat container.

### BRIEF DESCRIPTION OF THE FIGURES

FIG. 1 is an embodiment of the Halloween greeting system.

### DETAILED DESCRIPTION OF THE INVENTION

The Halloween treat container can be, for example, a bag or a pumpkin container. A voice recorder/audio player combination device can be attached to the container, either on the inside or the outside of the container. Although if the voice recorder/audio player is on the inside of the container, it should be preferably located at the top of the container so that the sound is not muffled by the treats that are going to be collected in the container. The voice recorder/audio player can be digital and preferably should be compact.

Parents may want to have their child record the phrases “trick or treat” and “thank you” as two separate recordings on the voice recorder prior to the beginning of trick-or-treating. When the child arrives at a residence and the door opens, the parents may want to wait to hear if their child says “trick or treat.” If the child does not say “trick or treat,” the parent can then press a key/button on a remote control unit for the “trick or treat” phrase to be played by the audio player. Presumably, the playing of the phrase will prompt the child to then say “trick or treat.” Similarly, as the child is ready to depart a residence, the “thank you” recording can then be triggered, if warranted. The use of the child's actual voice, as opposed to a canned “trick or treat” or canned “thank you” is preferable as it is more genuine and customizes the greetings. However, if the child has a disability that impairs/prevents speaking, the use of another person's voice (e.g., that of an older sibling who wants to help) might be a welcome alternative. The use of the voice recorder/audio player is certainly not limited to the above two phrases. Clearly, any sound that can be recorded can be used. And since it is Halloween, spooky Halloween music and/or scary Halloween sounds would be appropriate. The Halloween music/sounds (and any other sounds) can come pre-recorded on the voice recorder/audio player. Alternatively, the Halloween music/sounds (and any other sounds) can be recorded by the user. Perhaps, the children might want to have a contest to see who can come up with the spookiest, scariest sounds!

The remote control unit is preferably paired to the voice recorder/audio player, so as to avoid the indiscriminate triggering of voice recorder/audio players. Although given the festive nature of trick-or-treating, an occasional unintended triggering of the voice recorder/audio player is not necessarily a bad thing, since children can pretend a ghost or goblin caused the voice recorder/audio player to go off. It is envisioned that the remote control unit will be used primarily by a parent or adult chaperone. The remote control unit can have one or a plurality of keys/buttons. A separate key can be designated for each recorded message. This feature should facilitate the easy accessing of a specific recorded message in the dark (e.g., the key on right side of the remote control unit is for “trick or treat” and the key on the left side is for “thank you”).

In one embodiment of the present invention, the voice recorder/audio player can be removably attached to the Halloween treat container. The attachment can be by, but is not limited to, adhesives, tapes, clips, fasteners, snaps, zippers, threading, or pliable, adjustable holders.

In another embodiment of the present invention, the Halloween greeting system can be supplied as a kit that includes a voice recorder/audio player, a remote control unit for triggering the voice recorder/audio player, and an attachment for attaching the voice recorder/audio player to a Halloween treat container. The kit can optionally, further include a Halloween treat container. The container can be anything capable of holding treats, although traditional Halloween decorated bags or jack-o'-lantern pumpkin containers are preferred. The kit can optionally include messages that come pre-recorded on the video recorder/audio player. These messages can include scary music and spooky, scary sounds that capture the Halloween spirit.

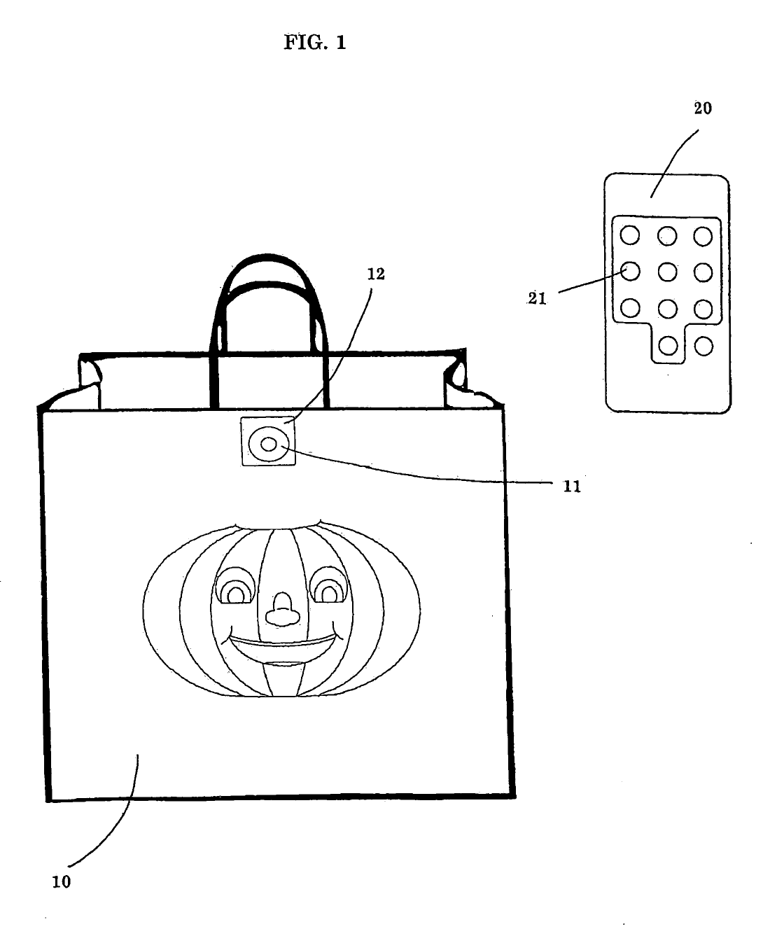

FIG. 1 is an embodiment of the Halloween greeting system. A Halloween treat container 10 has a voice recorder/audio player 11 that is attached by an adhesive mounting 12 to the Halloween treat container. A remote control unit 20 with a plurality of keys 21 is used to trigger the voice recorder/audio player.

The invention has been described in detail with particular reference to certain preferred embodiments thereof, but it will be understood that variations and modifications can be effected within the scope of the invention as described above by a person of ordinary skill in the art without departing from the scope of the invention. For example, an audio player device could be used in place of a voice recorder/audio player combination device.

What is claimed is:

1. A Halloween greeting system comprising:
a Halloween treat container comprising a voice recorder/audio player combination device; and
a remote control unit for triggering said voice recorder/audio player combination device to play a recorded message.

2. The Halloween greeting system according to claim 1, wherein said voice recorder/audio player combination device comprises a plurality of recorded messages, wherein said remote control unit permits selection of which recorded message is to be played.

3. A Halloween greeting system comprising:
a voice recorder/audio player combination device, wherein said voice recorder/audio player combination device is removably attached to a Halloween treat container; and
a remote control unit for triggering said voice recorder/audio player combination device to play a recorded message.

4. The Halloween greeting system according to claim 3, wherein said voice recorder/audio player combination device comprises a plurality of recorded messages, wherein said remote control unit permits selection of which recorded message is to be played.

5. A Halloween greeting system kit comprising:
a voice recorder/audio player combination device, wherein said voice recorder/audio player combination device is removably attached to a Halloween treat container;
a remote control unit for triggering said voice recorder/audio player combination device to play a recorded message; and
an attachment for attaching said voice recorder/audio player combination device to said Halloween treat container.

6. The Halloween greeting system according to claim 5, wherein said voice recorder/audio player combination device comprises a plurality of recorded messages, wherein said remote control unit permits selection of which recorded message is to be played.

7. The Halloween greeting system according to claim 5, further comprising a Halloween treat container.

8. The Halloween greeting system according to claim 5, wherein said voice recorder/audio player combination device comprises pre-recorded messages.
